(19) United States
(12) Patent Application Publication
(10) Pub. No.: US 2014/0130011 A1
(43) Pub. Date: May 8, 2014

(54) Re-programmable process for configurable software

(71) Applicants: Brian S. Dillon, King George, VA (US); Marin A. Kobin, Fredericksburg, VA (US)

(72) Inventors: Brian S. Dillon, King George, VA (US); Marin A. Kobin, Fredericksburg, VA (US)

(73) Assignee: United States Government, as represented by the Secretary of the Navy, Arlington, VA (US)

(21) Appl. No.: 13/694,401

(22) Filed: Nov. 7, 2012

(51) Int. Cl. G06F 9/44

(52) U.S. Cl. CPC G06F 8/34
USPC 717/113

(57) ABSTRACT

A computer-implemented processor is provided for enabling an operator to reprogram a configurable software product. The processor includes a composition graphical user interface (GUI) creator for producing a composition that modifies the software product by applying operational rules, and a memory for storing the composition. The composition includes an instruction set of commands therein as an adapted software product.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to configurable software. In particular, the invention relates to altering a program without reprogramming.

Computer programming is a cross between science, art form and engineering discipline. Good programming skills require education and training to develop. Software (or “code”) which is designed to work correctly, especially in a controlled environment, requires extensive and expensive testing. After testing and validating code it should be “locked down” in order to prevent users from changing the software and inadvertently introducing a new error. After lock down it should not be subject to additional changes by anyone. The current state of the art does not afford non-programmers the ability to alter software beyond menu preferences and especially after it has been locked down.

Conventional software development methods include waterfall, cyclic and agile. Typically, the waterfall method has the greatest stability of these over time, because it marches inexorably down a series of steps or phases from requirements to design to coding to test and finally distribution. FIG. 1 shows a simplified flow diagram 100 of the waterfall process, which begins with a set of requirements 110 and proceeds to design 120. Further phases sequentially include build 130, implementation 140, verification 150 and support 160.

Because of this lock-step nature of this process, the waterfall method has less ability to adjust course over time, and costs for implementing corrections exacerbate as step-marching advances. For example, a problem discovered during design or even in requirements can be adjusted with modest effort, but the same problem discovered during testing can impose significant rework in order to correct it.

Cyclic methods, including spiral and iterative approaches, necessitate completion of particular tasks (design, code, test), and after which the situation is evaluated before the next build. FIG. 2 shows a simplified flow diagram 200 of the cyclic process. Initial planning 210 provides input to a process cycle 220 that includes planning 230, requirements 240, analysis and design 250, implementation 260, testing 270 and evaluation 280. The result produces deployment 290. This method enables increasing or changing functionality over time as anything missed in the current cycle can always be considered or added to the next cycle. Each cycle, however, is really a mini-waterfall so it has many of the same characteristics including an overall limit to its ability to change over time. Cyclic methods also involve considerable time to finally achieve complete functionality. Generally, however, the duration of several cycles involves less time than the waterfall method.

Agile methods are based on two principles: shortened cycles or blocks with known agendas and operational software at the end of each cycle. FIG. 3 shows a simplified flow diagram 300 of the agile process beginning with a product backlog 310 and proceeding to a sprint backlog 320. The process proceeds to a sprint interval 330 with an initial month cycle 340 of 30 days and a secondary day cycle 350. Upon cycle completion, the product releases as a working software increment 360. These cycles are not only temporally smaller than those typically employed in a cyclic method (one month rather than six), they are also inherently designed to meet the required timeline for completing a specific set of requirements. In an agile method, the development team operates closely together during the short schedule to drive each individual requirement through the process. At the end of the agile block, the team evaluates the next set of requirements and begins again. The period for turn-around on any urgent need can be restricted to duration of two blocks or less. Also, the software is always newer than one cycle length.

Each category of development methods has comparative benefits and disadvantages. Waterfall generally requires more development time and greater cost, as well as being prone to schedule and cost overruns; however, this process can be more stable, more manageable and better documented. Cyclic is of middling duration, easy to start/stop in the middle of development, less expensive than waterfall, but prone to similar schedule and cost overruns. Another drawback involves difficulty to determine when completion has been achieved for a cyclic project. Agile has quicker response, can be cheaper to construct and more likely to produce a useful product, but this process requires a full-time dedicated staff of programmers, testers, requirements and design specialist be maintained throughout the change period, a team that can be very difficult to manage and direct. The cost of adding functionality to existing software can thereby be extremely large in proportion to the new feature.

Maintaining a piece of code is a lifelong project. Throughout the lifetime of that code users will report defects in the code. These may be of two types: bugs and improvements. A bug represents any fault in the software which causes unintentional results or behavior. For example, the programmer intends for the code to do operation “A”, but the code produces result “B” instead. An improvement constitutes an intended and desired change in the behavior of an existing well-behaved piece of code. These may also range from deeply intrusive changes (i.e. the whole program is wrong and must be redesigned) to nuanced changes (i.e. change the color of a button).

Bugs can range in criticality depending on the frequency of occurrence (e.g., only at leap century or alternatively every calendar day), and the severity of the error in the system (prompting, e.g., either an action to be repeated or abrupt and complete shutdown, i.e., “crash”) as shown in FIG. 4 with a consequence comparison map 400. Consequence represents the abscissa 410, frequency denotes the ordinate 420, and criticality represents the azimuth 430. Consequence severity ranges from trivial at the lower left extreme to serious at the upper right extreme. Frequency ranges from rare at lower left to often at the upper far left. The map 400 denotes a gray-scale field having the bottom corner (shown in light shade) progressing linearly (in this example) of increasing criticality to the top right corner (shown in dark shade), extending in opposite direction to the vector.

The speed, and therefore the cost, of correcting a bug or implementing an improvement is directly dependent on the design of the software and familiarity of the programmer with that design. Even a highly skilled programmer has a learning curve in order to become well-versed in the relevant software. Even a rare and trivial bug which can be fixed by a single line of code may require extensive research merely to source and discover that errant line. Attendant costs for fixing a relatively serious bug that requires extensive code revision may still be mitigated by employing a well-versed and ever-ready programmer to accomplish that task, if available. These constitute expensive propositions for either developing or perpetually maintaining skills in proportion to the cost of the actual fix. The cost of maintaining an existing software product can be prohibitive over any lengthy period of time.

### SUMMARY

Conventional software modification techniques yield disadvantages addressed by various exemplary embodiments of the present invention. In particular, various exemplary embodiments provide a computer-implemented processor for enabling an operator to reprogram a configurable software product. The processor includes a composition graphical user interface (GUI) creator for producing a composition that modifies the software product by applying operational rules, and a memory for storing the composition. The composition includes an instruction set of commands therein as an adapted software product.

The GUI creator provides icons with which to construct the composition. The processor can further include a memory for storing said commands in said instruction set. Various exemplary embodiments provide a compilation module for assembling and executing the adapted software product.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a block diagram view of a conventional waterfall process;

FIG. 2 is a block diagram view of a conventional cyclic process;

FIG. 3 is a block diagram view of a conventional agile process;

FIG. 4 is a graphical view of a conventional prioritization plot;

FIG. 5 is a timeline view of behavior and software progress;

FIG. 6 is a block diagram view of a generalized composition process;

FIG. 7 is a block diagram view of an exemplary composition process;

FIG. 8 is a flowchart view of an add“ing” suffix routine;

FIG. 9 is a flowchart view of an ly-“ing” suffix routine;

FIG. 10 is a flowchart view of a command program to add “ing”;

FIG. 11 is a flowchart view of a command program to add “Iy”;

FIG. 12 is a block diagram view of an instruction example for vehicle intersection approach;

FIG. 13 is a block diagram view of an instruction example for financial account access; and

FIG. 14 is a block diagram view of an instruction example for automobile alarm activation and response.

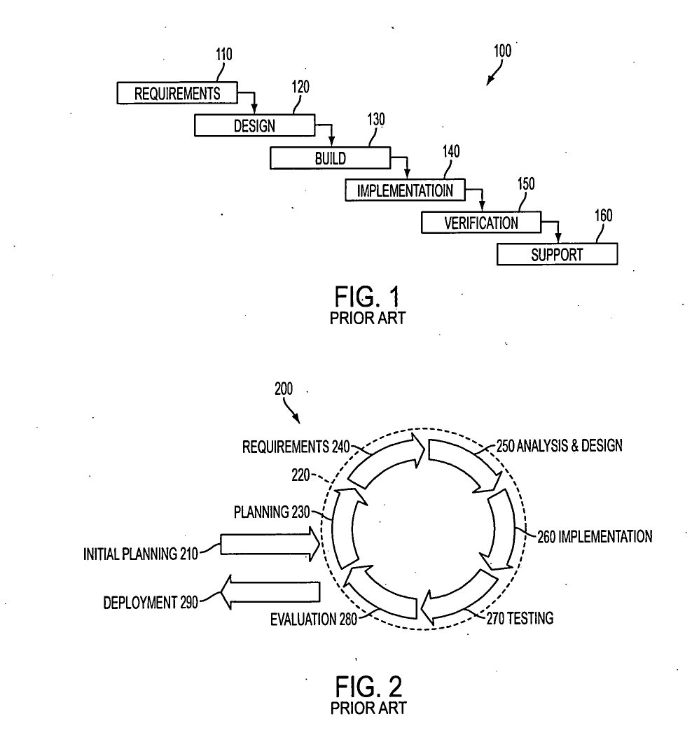

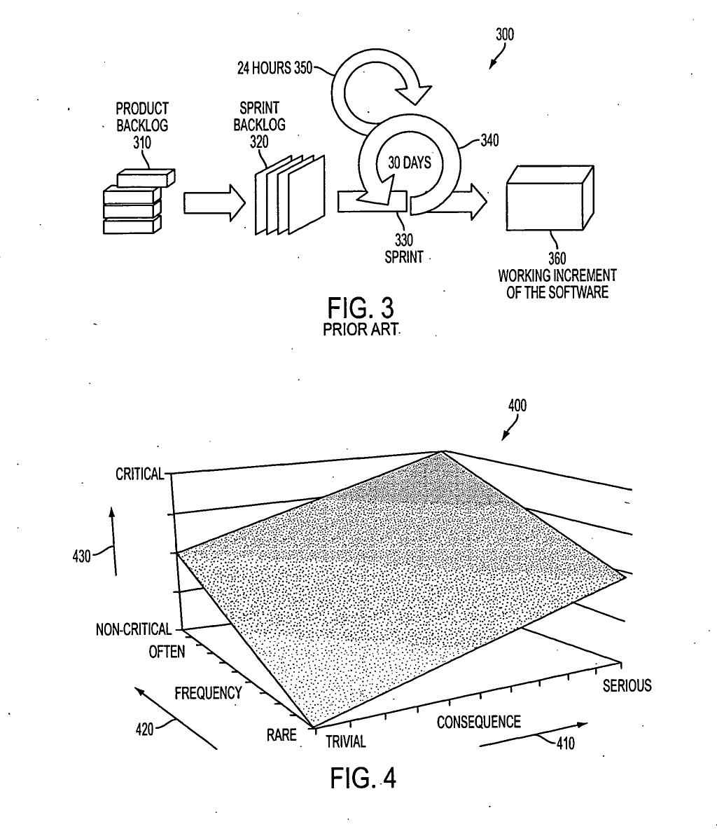

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC) or a floating point gate array (FPGA) or other related component.

Software configuration can generally be accomplished in one of two ways: user interactions and configuration files. User interaction refers to data that derive from the user (i.e., a casual operator) and stored by the system, such as in memory, to alter the system's behavior. This characteristic can range from the extremely obvious (i.e., box selection from “always” to “never again”) to the subtle (open notebook, resize/relocate notebook and close notebook, resulting in a change in the default position). Irrespective of user awareness of the manner in which the system tracks these actions, the user's actions alter the system to create changes in the program's behavior. With more overt changes, the user can create temporary or permanent behavior changes to suit personal needs (e.g., adjusting font size).

Upon program loading and execution, the processor reads a configuration file intended to alter the system's behavior. Some of these files, such as the firewall black/white lists for routers, are specific and overt to all operators. Other files may be hidden from the user, but are open to editing by authorized administrators. In a Microsoft® (MS) Windows® operating system, many applications maintain their current settings in the App Data folder. Some programs offer a separate program just for editing the configuration file. Others even offer the configuration file as a plain text file for the operator to edit at-will. Either of these methods is constrained by the expectation of the programmer. For example if the programmer has contemplated that the operator might desire the ability to invert the color of a picture, such an optional action may be incorporated in the graphical user interface (GUI). For example, MS Paint provides such color inversion by typing CTRL+I. At the same time, MS Paint does not allow selection inversion, such as provided by GIMP (Graphics-not-Unix Image Manipulation Program). This is due to a limitation introduced by the programmer.

Similarly the operator may expect a repeated action to become a permanent function associated with an edited documented, such as continually turning off auto-numbering in MS Word, but unless such a feature has been considered for inclusion, such capability may be absent in the software product. For example, a configuration file may not be able to accept a random comment like “turn off after one minute” or even a value beyond the presumed domain. The programmer's expectations impose limits on the system from the beginning. Those expectations cannot be deviated from without reprogramming the system. Additional or different behavior not expected at the time of programming cannot be added without involving a programmer after completion of the software development.

The exemplary processes described herein can be called a computer-implemented method for enabling reprogramming of configurable software product for non-programmers. The advantages derived from the exemplary processes alleviate the three deficiencies described in the background information, including:

(1) the cost of adding functionality to existing software being extremely large in proportion to the new feature's advantage;

(2) the cost of maintaining an existing software product becomes prohibitive over any lengthy period of time, and

(3) additional or different behavior not anticipated during program development cannot be added without involving a programmer subsequent to completion.

The exemplary method mitigates these issues by altering where, who and when behavior is added to the instruction system. By augmenting the design of the system to expect change, the system can remain intact and unaltered. By creating an imminently understandable interface for defining behavior the change can be affected by a relatively unskilled individual (i.e., casual user) without regard for (i.e., requiring knowledge of) the actual workings of the remainder of the system. By insisting that system behavior be defined outside of the system, the exemplary process changes the paradigm where finished code cannot be changed after that time.

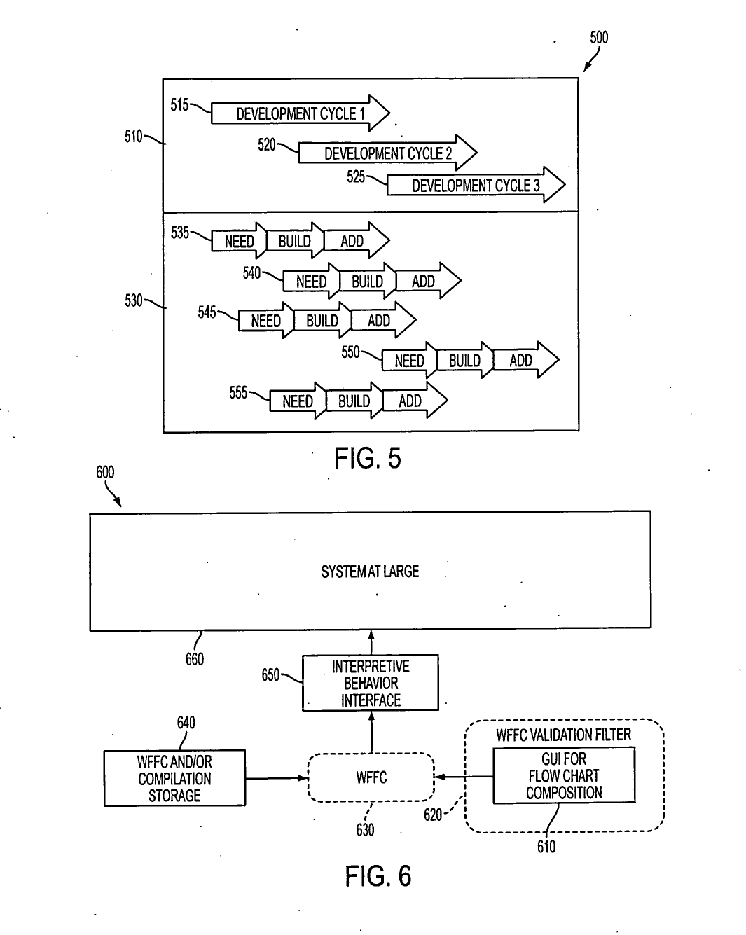

Compared to the other development paradigms, the exemplary processes can be compared to an asynchronous and parallel process for altering behavior. Shown in FIG. 5 as a series of need-build-add cycles, the exemplary process enables a non-programmer to create new behavior patterns, and to alter existing ones on an as need basis. The build process is abbreviated because there is no heavy coding or recertification. When the new behavior is tested and ready it can be added to the system without delay. All of these operations can proceed concurrently for multiple users without being constrained to any particular development cycle for the main software. The result is quicker turn-around time, lower cost for development/testing and a more user-need driven development paradigm.

FIG. 5 shows a timeline diagram view 500 of software and behavior developments. The main software development 510, distributed among first cycle 515, second cycle 520 and third cycle 525, for example. These cycles involve code writing based on requirements, and revising to correct errors found from testing. Independently, behavior set 530 provides modification options that do not require programming. These include separate timeline cycles 535, 540, 545, 550 and 555 each including steps for need identification, build process and add functionality.

Implementation of the process can be described as a generic example of a fictional software product with a hypothetical “the Alphabet Company, Inc.” (TAC) building a new software product that expects to create widgets based on the user's design. While the domain of widgets is well known, the method of creation has not been established. In other words, all the components that might be used in creating a widget are understood. However, what remains undetermined is the process of composing (i.e., selecting and arranging) the exact subset of these widget parts or components, because such a step can be open to interpretation. The widget parts are labeled with a letter of the alphabet, among various available text symbols. The arrangement of the parts is therefore analogous to building words, which constitute widgets. Example set of widget parts: {A, B, C, D, . . . X, Y, z}. An example set of sample widgets includes: BARK, ALBINO, HUT, MEANDER, GRAVITATIONAL).

There are several conventional ways of handling this unknown composition process. The first defines the development process so that new user requirements are anticipated and enfolded in the next software release. Whether choosing a cyclic or agile process, this can incur a delay in creating the new arrangement, and users may lose interest in that interval. Moreover the cost of maintaining the code over a lengthy period may cost more than TAC can afford. The second option is to create a few options which can be composed by the user through a configuration file or GUI.

As an example of the second instance, the programming team may consider the use of vowels A, E, I, O and U essential between the other parts. This leads to a great deal of widget patterns (CATAPULT, FUR, TOWER, etc.), but is demonstrably incomplete as this arrangement disallows some cases such as THEN and STAR. The preconceived rule may enable unlimited configurability, but lacks crucial functions so that another potentially legitimate set of widgets would be disallowed, thereby excessively restricting widget creation functionality. Such constraints would be very bad for the TAC business, as this would disable or render inconvenient many programming options.

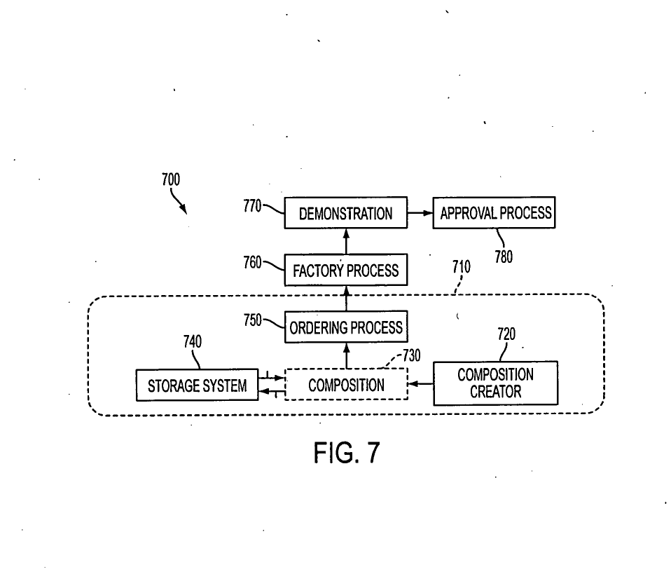

The exemplary method provides a solution to this conundrum. Incorporating standard computer science techniques, the software can be built modularly, as described in conjunction with in FIGS. 6 and 7, leading to a simple interface. The unknown composition behavior may be defined by the user in the Composition Creator to produce a composition that can be fed into the ordering process that facilitates Widget creation. Each of the solid-border modules can be built by TAC software teams without any knowledge of the actual behavior required in composition. Note that TAC may decide to develop a few “default” behaviors in order to ensure their software is operational both for testing and distribution, but these behaviors are only suggestions and are not a limitation on ultimate behavior.

FIG. 6 shows a flow diagram view 600 of a generalized composition process as performed by an exemplary flowchart composition process system 610 with a GUI. The composition 610 composes a well-formed flowchart (WFFC) 630. The GUI composition 610 can be enveloped by a WFFC validation filter 620, which provides a measure of validity checking before a WFFC can affect the system at large. The WFFC filter 620 can be stored in or retrieved from compilation storage 640 as the WFFC 630 and/or compiled version of the instructions. The WFFC 630 can then be submitted to an interpretive behavior interface 650, which follows the WFFC 630 to affect behavior of the system-at-large 660.

Central to the process in view 600, this GUI or creator 610 represents a processor that assists in creating the WFFC 630. As such, the WFFC validation filter 620 assists the non-programmer to ensure there are certain key steps in the flowchart (e.g., conditions on all branches, starting points, ending points, etc.) and facilitate adding new steps (e.g., adding a display element can result in questions about items to be shown). This creator 610 may also have very domain specific elements that are best created through the creator 610. If the system is intended to create new flowchart elements and/or limit the subset of flowchart elements these additions or limitations can be made as part of the creator 610.

The programmer creates the GUI for flow chart composition and provides that result with the validation filter 620 aiding the laymen user to create the WFFC 630. Within the storage 640, the composition is then known as the “behavior” which is interpreted by the interface 650 and enacted by the system 660 as a whole. The interpretive behavior interface 650 incorporate one or more design patterns in order to produce this effect.

Design patterns constitute well-known forms which repeatedly appear in object oriented code. The design pattern “command” is identified by an object that recognizes instructions to manipulate a larger system to cause an effect. For example an object may be used to add a character to a line of text. Commands are completely self-contained, usually incorporating an undo version of the desired manipulation should that be required.

The design pattern “strategy” is identified by an object that implements an interface used by another object to request a behavior. The larger object can be ignorant as to the details of the strategy object and indeed multiple strategies may exist so that one may be substituted to effectively change the behavior of the larger object. Essentially, the difference between these two patterns involves distinguishing which object is the active participant and which is passive. Either pattern could be used at the point where the behavior is interpreted for the system at large.

FIG. 7 shows a flow diagram view 700 of the TAC widget factory software being formed by an exemplary composition process system 710. A non-programmer GUI or composition creator 720 provides an interface having a set of icons, each representing an instruction or function, such as an IF-THEN-ELSE decision query. An operator (i.e., user) uses the creator 720, constituting a toolbox for behavior modification, to produce a behavior composition 730, which can be saved in and retrieved from a storage memory 740 as source code or a compiled object code. The composition 730 can be read or linked in an ordering process 750 to produce a particular behavior based on user supplied parameters. For TAC example, the instructions continue to a factory process 760 for assembly and compilation based on the ordering process 750, followed by a demonstration 770 to verify functionality and an approval process 780 for validation.

Exemplary embodiments for the system 710 involve three components. The first is the non-programmer GUI, which is represented by composition creator 720. The second is the system interface that is represented by ordering process 750. The third is the interim storage which is represented by storage memory 740. The non-programmer GUI or creator 720 represents all the atomic actions that the non-programmer may make use of in creating new behaviors. These features can be controlled via a computer processor that operates with at least one processing unit, system memory, an input device, an output interface and optionally a network interface. The processor connects to an external remote device via the network interface. The processing unit performs the logical operations for composition and ordering, among others.

The system interface or ordering process 750 represents the technique in which the system responds to the WFFC. Reading the flowchart should be a fairly universal process, but certain domain specific issues must be considered: Where will displays be rendered? Where are data written to or read from? What operations does the system perform in the period between stopping one process and starting another? The system interface as ordering process 750 handles all these decisions. In essence, this module heavily uses the command and/or strategy patterns. By enabling the individual behaviors to be created in the composition 730, composed and selected by the users, the composition creator 720 creates a virtually limitless domain of behaviors that can be used to affect the rest of the system.

Interim storage 740 is the means of storing the codified WFFC and any pre-interface interpretation. Some form of optimization can probably be achieved if the WFFC is “compiled” for direct read from the system interface 750. The storage memory 740 may even directly translate the WFFC into compiled format as long as the instructions can be reverted for further editing in the future. The exact form of interim storage is to be determined by the programmer.

TAC programmers can create a simple GUI for the composition creator 720. The user can load the specifications for a new part, along with its letter designation at any time. The user may create a limited behavior such as the “add-ING” behavior subsequently described in further detail. These behaviors can be composed into larger behaviors based on blocks of existing behaviors such as the behavior to form adjectives also shown below. The only addition which TAC programmers created for the Composition Creator were a dichotomy between widget parts known as vowels (A, E, I, O and u) and all other parts and a list of several known widgets in two categories: verbs (e.g., GO, COME, DO, etc.) and nouns (e.g., BAT, TOWEL, CAR, FIST).

The TAC programmers can create a limitation based on the domain knowledge expert's opinion that no widget can exist without a vowel. They also can create limitations on the read/write functionality so that each widget is created separately. Data events may still upload a series of widgets, but the widgets are each read/write autonomous. These logical steps to the processes can be constructed using the icons provided in the creator 720.

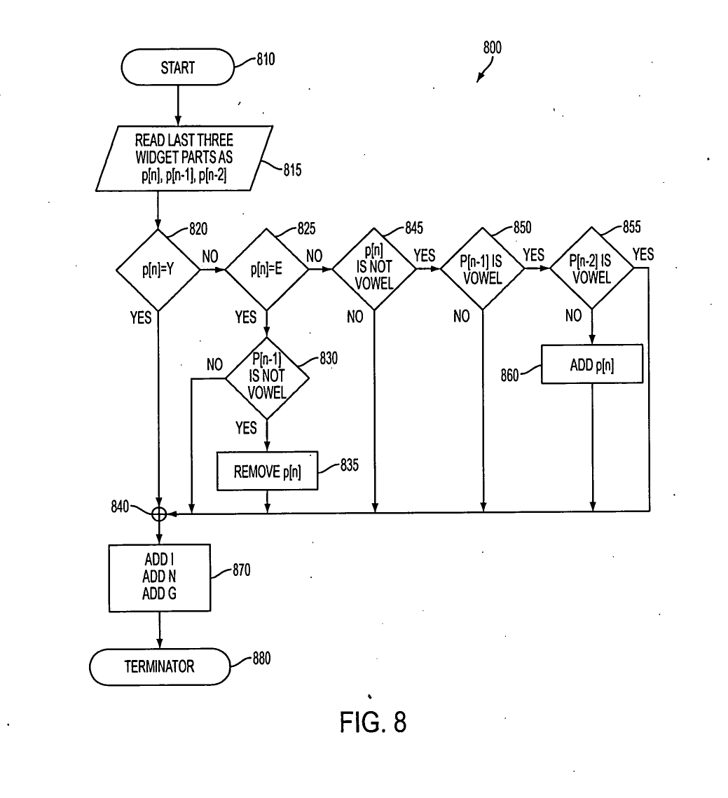

FIG. 8 shows a flowchart view 800 of an add-ING gerund process as an exemplary operation. A start 810 initiator receives input data for an input reader 815 to read the last three widget parts as p[n], p[n−1], p[n−2] from a series of widgets. The read parts are sifted by a series of decision logic gates, beginning with the first query 820 for whether p[n]=Y? If no, query 825 asks whether p[n]=E? If yes, query 830 asks whether p[n−1] is not a vowel? If no, block command 835 removes p[n]. Then, or if the answer to query 820 is yes, the operation reaches a joint link 840. If no to the query 825, query 845 asks whether p[n] is not a vowel? If yes, query 850 asks whether p[n] is a vowel? If yes, query 855 asks whether p[n−2] is a vowel? If no, block command 860 adds p[n]. Following the add instruction in command 860, or if queries 845 and 850 are no, or if the sixth query 855 is yes, operation proceeds to the link 840. Then block command 870 adds I, adds N and adds G, after which the process terminates 880.

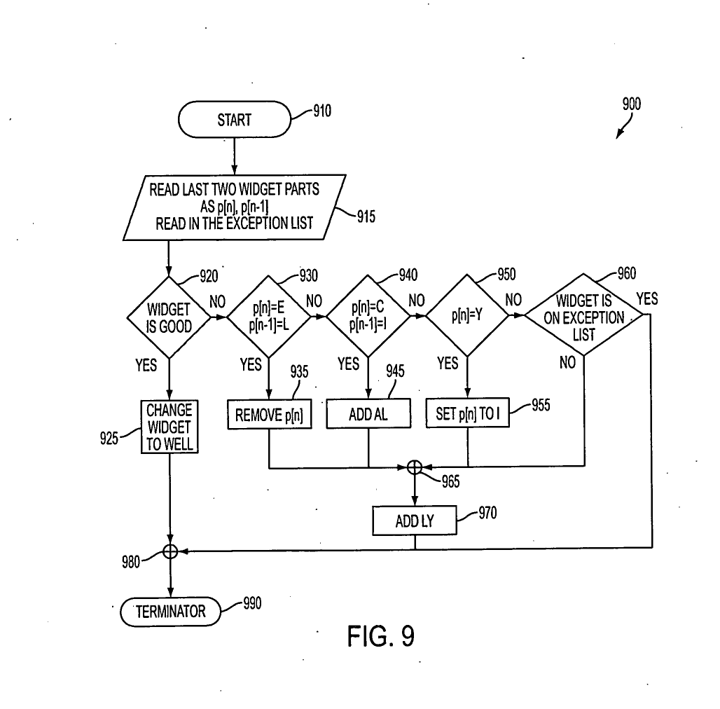

FIG. 9 shows a flowchart view 900 of an add-LY process as an exemplary operation. A start 910 initiator receives input data for an input reader 915 to read the last two widget parts as p[n], p[n−1] from a series of widgets. The read parts are sifted by a series of decision logic gates, beginning with query 920 for the special case where the whole widget is “good.” If yes, then block command 925 alters widget to “well.” If no, query 930 asks whether p[n]=E and p[n−1]=L? If yes, block command 935 removes p[n]. If no, query 940 asks whether p[n]=C and p[n−1]=I? If yes, block command 945 adds AL, and if no, query 950 asks whether p[n]=Y. If yes, block 955 sets p[n] to I. If no, query 960 asks whether the widget is on an exception list. If no, the operation proceeds to joint link 965, as also following blocks 935, 945 and 955. The link 965 leads to block 970 to add suffix LY. If yes to query 960, the operation proceeds to joint link 980, as also following the block 970. From the link 980, the operation terminates 990.

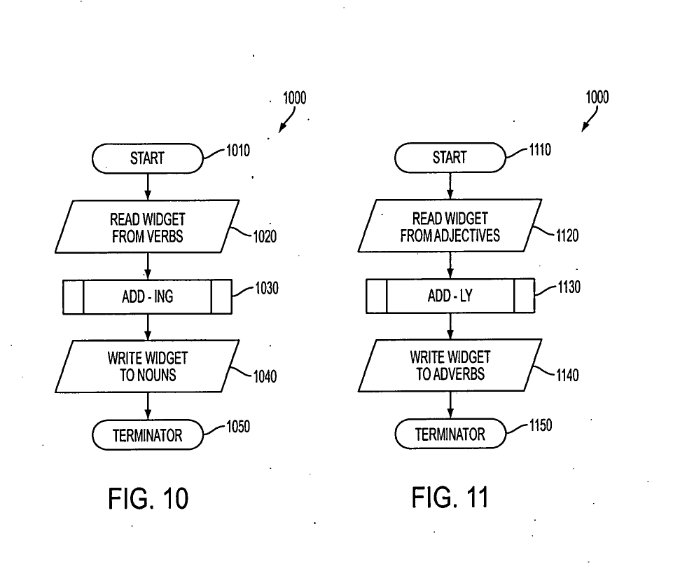

FIG. 10 shows a flowchart view 1000 of a command program that calls the add-ING gerund process flowchart 800 as a subroutine, as needed for a language instruction or construction process. A start command 1010 initiates by an input operation 1020 that reads a widget from verbs. The operation calls the add-ING subroutine 1030, followed by an output operation 1040 that writes the widget to nouns. The process then terminates 1050.

A similar process can be derived as FIG. 11 with a flowchart view 1100 of a command program that calls the add-LY process flowchart 900 subroutine for converting adjectives to adverbs by appending a suffix. A start command 1110 initiates by an input operation 1120 that reads a widget from adjectives. The operation calls the add-LY subroutine 1130, followed by an output operation 1140 that writes the widget to adverbs. The process then terminates 1150.

The TAC, programmers also created the Ordering Process with the aid of their domain knowledge expert. Having limited the read/write and data events of the composition creator 720, the programmers recognize that they will be given a list of parts as in “E-N-V-E-L-O-P-E” that shows the order of their composition. The programmers may also receive a list of these lists so that many widgets may be specified by a single behavior, e.g., the list contains parts lists such as {“T-H-I-S”, “I-S”, “A”, “S-E-N-T-E-N-C-E”}. Knowing how to connect and join these parts from the domain knowledge experts they can then create ordering instructions for the factory. The Factory process connects the parts into widgets according to the ordering process (e.g., “Envelope, this, is, a, sentence”). The final stage is to demonstrate the finished widget to the user and verify that the widget is composed correctly. These operations can be considered as supplementary to the inventive process.

Finally, the TAC programmers opted to store in memory 740 the flowchart data as an extended markup language (XML) document, but also to compile the code as a set of instructions for the ordering process 750. This ensures completion of any compilation processes prior to executing the program, rendering the process resistant to delays at the run time. The storage memory 740 runs asynchronously to the composition creator 720 so that after saving the file as XML, memory 740 continues to execute the compile process in the background. This also avoids any delays before the composition creator 720 can be closed, although memory 740 may run in the background for some time.

Composing Behaviors: As shown in the example in FIG. 10, the flowchart 1000 involving add-INS in the gerund processes, an important advantage of the exemplary method is the ability to compose behaviors in new ways. Once a behavior has been defined, its characteristics can be made available for retrieval and reuse in any new behavior. For example, the mechanical behavior learned in tying a bow can be useful when working with shoes, parcels, presents, bonnets, robes and hats. Rather than relearning the same behavior in each case, that technique need only be learned once and then re-implemented in each of these other cases.

In the case of TAC, the programmers may choose to implement a variety of well-known composition patterns defined by the domain knowledge experts. For example, non-programmer users may be aware that a variety of widgets can use the components -TION as an extension. Such users may also recognize that similar suffixes -ARITY, -NESS, -LESS, -TIVE and -TURE might be well known extensions. The behavior of adding these extensions may be composed, and that same behavior may then be applied to a number of different situations as subroutines such as 1030 and 1130.

Again, the power of the exemplary method obviates limits to the behavior of the system to the programmer's expectations. Suppose that users very quickly develop the idea that a classification of widgets called adjectives needs to be defined and that a variety of well known widgets can be defined and added to the adjective group. The users may then proceed to define a new group called adverbs and a process called add-LY. They may finally create a composition rule that can create adverbs from adjectives based on their own domain knowledge expertise (e.g., routine add-LY too must permit various rule combinations). These are two new groups a behavior and a way of automatically creating new widgets from old that were never considered by the programmers, and the system is still capable of following these new behavior rules without recertifying or even modifying the main program.

Not only can new functionality be created without altering the baseline code, but small changes can be made that have far reaching effects. For example, a managerial edict may insist that AIN'T is no longer an invalid verb type, and the programmers at TAC desire to make this adjustment to the program's behavior. Assuming that they used a composition behavior rule to define AIN'T as invalid they would only need to submit a new rule changing this fact. Once this has been distributed to their users, there would be no further adaptation of the system. Even if a user had created a multitude of verb creation rules that ultimately uses the validation rule, the change in the validation rule does not alter the user-defined verb creation rules. The user simply acts on the predefined process in the current form (i.e., with the new AIN'T rule in place). This also applies to user defined rules so that if add-LY were altered that feature would automatically be updated in the Adverb from Adjective rule.

Although behavior can be changed by anyone with limited logical capabilities, there remain advantages in developing experience in building the rules correctly and testing. The old saying among programmers is “garbage in, garbage out” or GIGO. Thus, incorrect programming will accomplish the wrong result, non-compliant with the objective. While the skill level required to make these behavioral changes is not nearly as high as that required for programming in the true sense, the user must at least be familiar with flowchart logic and certainly will benefit from expertise in the area. In addition, any new process or altered process should be tested before it goes into full use. Thus, the programmer may develop a limited version control system as part of the non-programmer GUI. This enables the user to test the process without affecting the system at large. The degree to which version control is implemented will depend on the consequences should the system be upset.

The exemplary process as it has been explained herein depends on several technologies and techniques which are well known to those well versed in the art of computer science. The idea of building a modular system where one module defines behavior for the rest of the system is not new. Neither is the concept of a piece of “code” being interpreted on the fly rather than compiled. What makes this technology novel is the specific combination of these features in a way that enables the programmer to create software which is fully implemented, tested and accredited, but which may be adapted to an extreme degree without invalidating that accreditation. A brief survey of these topics follows, together with a contrast and comparison with the exemplary method.

Just in Time (JIT) Compilation is the practice of not compiling or linking software until required. This may be because the compilation is expensive and perhaps not required or because the code itself may be subject to change just prior to usage. Contrasting this with the concept of a compiled language there is more overhead, but less original work. Generally the only perceivable difference is a slight delay at startup. Contrasting this with the concept of a purely translated language the JIT compiled language is much more rapid.

The process is similar to a JIT outlook in that changes to the compiled code can be made right up until run time. However, this may more closely resemble a directly translated language depending on the storage system. The hypothetical example of TAC's program has considerable similarity to JIT Compilation, but a decision not to pre-compile would be much more like a translated language. Note that JIT Compilation, although used for this example, does not satisfy the need to make programming possible for non-programmers.

Translated languages for computer processes include those in which the code is not compiled and linked in order to create “native” code for execution on the system. These languages are markedly slower than a true compiled language, but have the added advantage of being non-native (i.e., not specific to the processor platform or its operating system). Often the mapping between the non-native code and the native code is sufficiently simple (i.e., Add 1+X translates to Load x; Increment x) that any degradation in performance hit remains tolerably small. Provided a lack of absolute optimization being required, this technique is acceptable for cross platform solutions.

The process employs a translated language in that no flowchart diagram is exactly identical to a compiled language and will be translated at some point. If, as explained above, no attempt is made at pre-compiling the WFFC, then it will be an almost pure translation process when the WFFC is “executed” as part of the program. Similar to JIT Compilation, this technology is not sufficient to make programming possible for non-programmers.

A visual language is one where the language is mainly GUI based and consequently thrives on button events and other such visually accessible actions. Indeed this is a very easy framework to learn and many non-programmers can become somewhat proficient in this type of language. There is, however, a limit to what can be created with a visual language. Without delving deeply into the code nearly all applications will be no better than a superficial interface. Some examples used in university classes make use of already written code provided by the instructor, but which require the student to create the interface to access the hard-coded behavior. While the graphical creation of a flowchart is much akin to a graphical composition of a GUI they are not equivalent. A visual language creates behavior on the back end which is largely hidden from the user who creates the GUI. Conversely, the method allows the user to create the behavior which is largely unknown to the existing GUI or system. The second option is a much more powerful tool.

Plug-in frameworks depend on an interface point which all plug-ins share and which allows them to access functionality embedded in the system. Theoretically, if a system were to abrogate its right to define its own behavior to at least one plug-in that might be written, this would be very similar to what is being accomplished by the exemplary process. The system itself is devoid of behavior patterns and all behavior comes from an external source. This process also has a system that is devoid of behavior patterns, and all behavior originates from an external source. The distinguishing characteristic, however, is still the inability of a non-programmer to create a plug-in. The interim storage may be designed to code the behavior into a compiled plug-in, which may then be used by the system. However, that represents an implementation choice rather than a requirement of the system. Stated more simply a plug-in does not constitute the method, but the method may include a plug-in.

A dynamically linked library or DLL is a set of compiled binary code that is not part of the system, but may be loaded to enhance the capabilities of the system. In other languages the DLL may have a different name (e.g., JAR files in Java), but the function is still the same. The system has a certain set of behaviors prior to including the DLL, and a new or augmented set of behaviors after including the DLL. However, the DLL is still only to be written with a programming language and is therefore inaccessible to the non-programmer. Similar to the treatment of plug-ins above, a DLL may be the implementation choice for interim storage but does not inherently attain all the features of the method and is not necessarily required to make the method work.

Design patterns are well-known methods of creating compositional and extensible software without too tightly defining the functionality of the software. As noted above the system interface may make extensive use of the strategy or command patterns. Other patterns such as chain of responsibility, template and composite are similarly useful. These patterns, however, still depend on additional code which must be part of the system in order to function. While these packages of code may be created using plug-ins or DLLS and design patterns may make their inclusion smooth and seamless, they still require code or they face limitations.

One of the limits of pre-defined code is that such instructions can only be composed, not redefined. In other words, if behaviors A, B and c are known, a user can create an infinite number of variations by composing these patterns of behavior (e.g., ABBA, CBAC, AAA, ABABAC). Nonetheless, pre-defined code does not permit creation of an entirely new behavior D. While the reasonable use of design patterns would enable the user to compose behaviors from any existing set of behaviors, pre-defined code does not enable the user to create new ones.

Flowchart algorithm tools such as Logicoder can produce actual code. An algorithm is a set of logical steps that if followed will produce a certain behavior. In a purely algorithmic sense a flowchart can contain all the logic necessary to create behavior and indeed many unified modeling language (UML) based tools make use of flowcharts in order to create sequence diagrams that can effectively be translated into actually coded algorithms.

This category of code-creation tools is excellent in producing algorithms and are somewhat similar to the non-programmer GUI used in the method. They differ, however, in one large respect: the code created thereby is not usually more than a skeleton of the actual requirements and is not ready for insertion into a system. Moreover, there is no expectation that the system will be prepared for the code to be inserted. The process includes both sides of this divide in that the produced WFFC is complete in itself and that the system is expecting the input from the WFFC. One can note that typically a programmer's level of skill is necessary to use these tools.

Flowchart based systems, such as Arena (a modeling and simulation tool), employ flowchart logic for much the same purposes that it is used in the method. Tools such as Arena want to get around the constraints of using a programming language to reduce the learning curve. At the same time these tools are attempting to produce a nearly Turing complete system (i.e., equivalent to a computer). A user cannot accomplish both concurrently, and in more complex flowchart-based systems such as Arena, this becomes apparent. Arena has much of the needed programming built into the flowchart, but there are a number of places where the user much adapt the flowchart further my dictating events, spacing, distribution of events and other such items. In still other places the user can only create the desired effect by pseudo coding events and event handlers to be included elsewhere in the model. In effect the system still depends on programming, albeit a localized form, in order to accomplish its tasks. The result is a system based on two learning curves and the user must nonetheless learn programming to use the system for the conventional arrangement.

Further exemplary embodiments include computer-led training systems. In one of these examples, suppose a training system for new drivers which will record their reactions and give feedback after multiple simulated experiences. Various embodiments provide an interface by which new simulated experiences might be created. The trainer could create or alter simulated scenarios and these would produce the behavior of the simulator used during the computer led training.

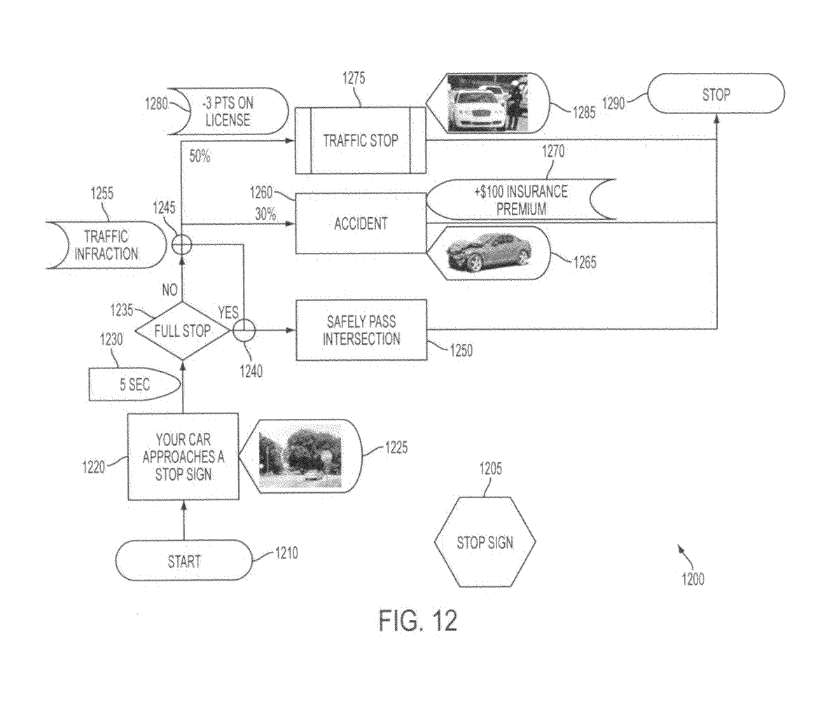

The process can be instantiated as part of a training system in which exemplary training examples are described. First, FIG. 12 shows a block diagram view 1200 of intersection approach under by a motor vehicle under road traffic scenarios. The process starts 1210 with a first block 1220 at which the car approaches a stop sign as indicated by an iconic illustration 1225. After an interval 1230 of five seconds the system engages in a query 1235 which assesses if the car has come to a full stop. If the driver has stopped, the system proceeds to a second block 1250 for safe passage through the intersection. If the driver has not stopped, then a traffic infraction 1255 is recorded. Additionally, probabilities exist for alternate scenarios. Proceeding without a stop leads to a 30% chance of an accident 1260, as indicated by illustration 1265 and an increase of insurance premium 1270. Alternatively, proceeding leads to a 50% chance of a traffic stop 1275 with consequence of demerits 1280 from the driver's license, as indicated by illustration 1285. The remaining 20% chance will pass through junction 1245 to junction 1240 indicating a safe passage 1250. Following the pass block 1250, the accident block 1470 and the citation block 1275, the process terminates 1290.

Various exemplary embodiments enable any workflow to be defined by one individual and second individual or group of individuals to then be guided in exactly the same steps. This produces a universal response method as all individuals are following the same proscribed methods. Such examples would apply to various uniform response groups, such as call centers, where consistent workflows are important. The exemplary processes offer additional advantages over typical software for these groups so that a non-programmer can adjust the script, sequence and other events at any time.

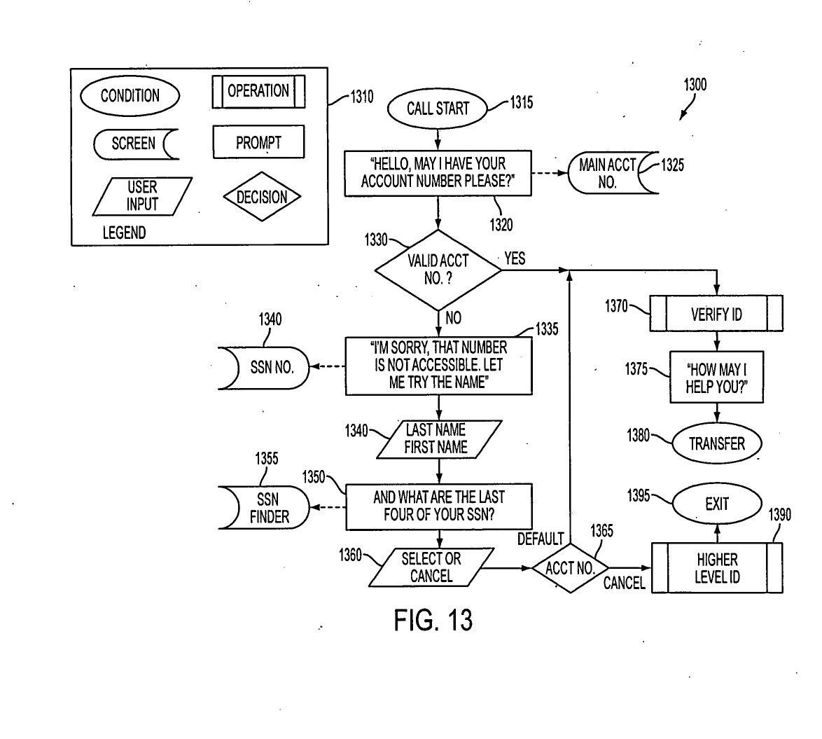

Additional training examples are provided for illustration purposes. FIG. 13 shows a block diagram view 1300 of call center operations. A legend 1310 provides icons for flowchart elements, including condition-of-field (for call routine), screen+field display; prompt; and user-input; decision-branch. Note that line arrows indicate logical flow, whereas dash arrows indicate coinciding events. A computer system executes the process that begins with start 1315, leading to a first prompt 1320 to ask “hello, may I have your account number, please?” This coincides with a first screen access 1325 to a main account number. The prompt 1320 leads to a first query 1330 regarding the account's validity. If no, a second prompt 1535 reports “I'm sorry, that number is not accessible. Let me try the name.” This coincides with a second screen access 1340 with first and last names and is followed by a third prompt 1350 that inquires “and what are the last four of your SSN?”

A third screen access 1355 presents a finder list with which to search SSN to identify a match. A second user input entry 1360 provides an option for select or cancel. The entry is compared to a second query 1365 for a valid account number. A yes for the first query 1330 or default for the second query 1365 leads to a verify identification operation 1370, which after successful termination leads to a prompt 1375 to ask “How may I help you?” followed by call transfer 1380. A cancel response, associated with an invalid account number, to the second query 1365 leads to a higher level identification operation 1390 and then termination 1395 from the call center.

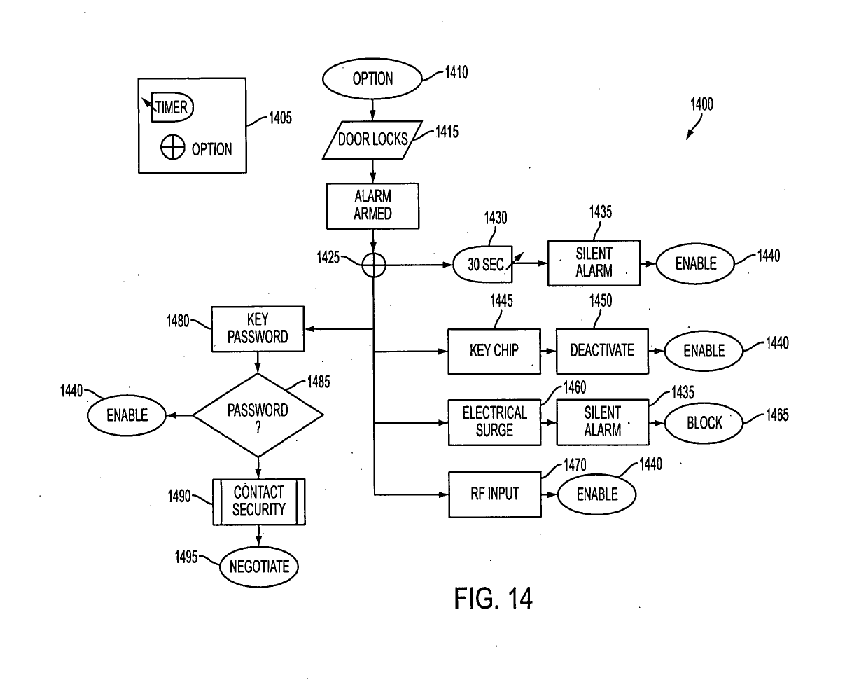

FIG. 14 shows a block diagram view 1400 of a composition for a car alarm system produced in accordance with exemplary embodiments. A legend 1405 provides icons related to timer and options. The process begins in standby 1410. An instruction user input 1415 locks the doors, setting a prompt 1420 that arms the alarm. This leads to a branch 1425 that enables several options. The first option includes a 30-second delay timer 1430 leading to a silent alarm prompt 1435, which can be set to an enable terminal 1440. The second option includes a key chip 1445 that switches the alarm off 1450 and then set the enable terminal 1440. The third option includes an electrical surge 1460 that activates the silent alarm 1435 and then set a block terminal 1465. The fourth option includes a radio-frequency input prompt 1470, followed by the enable terminal 1440. The fifth option includes a keypad password prompt 1480 that queries password validity 1485. If yes, the process sets the enable terminal 1440, and if no, a signal transmission 1490 sends a warning message to an external contact followed by negotiate terminal 1495.

Various exemplary embodiments enable a non-programming operator to employ standard flowchart icons, connections and terminology to create a pseudo-program which can be executed by the configurable software product. As an example, software used to train new drivers can be produced to read the exemplary pseudo-program and execute instructions accordingly. With minimal effort trainers can design new training scenarios that include pedestrians entering the roadway, stop light changes, new signs, police intervention and a virtually Unlimited set of situations. In other domains, the same technology would allow medical personnel to be trained in diagnostic skills, lawyers to be trained to handle courtroom proceedings and any technician to be trained in their field.

Conventional techniques employ menu-driven features can be toggled between on and off buttons, or alternatively adjusted along a linear scale using a sliding icon. The use of features enables the operator to configure the actions of the program with respect to options the programmer has already included, but does not provide for major changes in functionality. By contrast, exemplary embodiments alter that paradigm by prompting the operator to construct a code around a flow-chart engine and thereby produce an executable program. The operator, in effect teaches the program to operate by whatever rules the flowchart dictates, building features based on the flowchart details.

The features of a flowchart operate much like a “choose your own adventure” book and are well known in a variety of technical fields. A section of the “story” takes place at one point and then the user is directed to make a decision. Decisions are typically yes/no but may include more branches where appropriate (e.g., “do you turn left, right or go straight?”). Decision branches lead to different story sections. Unlike the “choose your own adventure” books flowcharts offer a great deal more scope for the writer. There can be external databases that are updated, triggers to other events, timers that are set off, documents that are updated and a number of other occurrences. Using basic flowchart technology, anyone with a minimal amount of training would be able to create highly complex workflows, training scenarios and instruction sets that would be loaded into the configurable software product and become an operational reality.

In addition to the power of the flowchart, this invention creates these events, etc. as individual components that can then be aggregated to a larger whole. Returning to the driver training example in flowchart view 1200, suppose that a four-way intersection was defined as a decision type, an ambulance passing through was given as an event type, and a stop sign as an event type. Then a trainer could use these rudimentary components to compose a larger scenario with a driver being forced to yield to an ambulance at a four-way stop. By inserting each of these definitions into a relational database, an improvement in any of the basic components can be achieved to instantly update the larger scenario. This provides the user the ability to examine each component separately in detail while still maintaining the complexity of the whole at another level.

For nomenclature purposes, there are three actors for these exemplary embodiments: the programmer, the trainer and the trainee. The programmer creates a configurable software product, in this case a training engine, which handles the input from the flowchart system and uses that system as a basis for the software interaction with trainee. The programmer handles such details as occurs when the trainee hits the gas pedal, etc. The trainer works directly with the flowchart engine and requires no programming experience. The trainee observes and interacts with the combination of the training engine's interface and the flowchart's logic. The result is a seamless training product that the trainee can use.

The trainer is able to create a flowchart like that shown in the attachments. It describes the act of passing through a stop sign with the obvious implications to trainee score, notification and other events. The single component can be composed into a larger flowchart as a predefined task. In fact the block indicating a traffic stop is, according to this diagram, another predefined task which presumably is defined by another flow diagram. Other features shown in the example are multiple branches after an event based on a given probability (50% traffic stop, 30% accident, 20% safe passage), recording decisions in a log.

This process applies to applications where synthesizing processes is a priority, particularly phone centers. Such processes can be created and followed with complete accuracy while being open to change at any time. This means that policy can effectively be set from above while the larger group below follows the policy per force.

This process also applies to training applications where the priority is teaching a sequence of steps. Procedures that are must be followed will be included into this set. Consider the case of learning to file a motion as part of a court case. Knowing when these motions must be filed, what deadlines are important, etc. these are all steps in a rote process which is informed by a few given values at the beginning (e.g., is this a criminal proceeding, is there evidence taken from the defendant).

The navy applications which have been proposed include a training system which teaches urban combat, awareness and rules of engagement. A second application is a phone center which handles information technology (IT) help requests from the field. The method described here will be used to create a tree of questions which cascade to a known problem and solution. In each case this method will serve to create standardized processes which are open to editing and change when justified.

Advantages and new features.

Decrease software costs.

Decrease software build-time.

Increase software reliability

Decrease training costs.

Increase process reliability.

Increase process repeatability.

There are no processes or methods that can implement the exemplary processes in a cost-efficient manner. The only alternative to implement changes requires significant reprogramming, resulting in increased time and cost for new software. Variations on a central theme might be created, but the program would still have a native inflexibility.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented processor for enabling an operator to reprogram a configurable software product, said processor comprising:
a composition graphical user interface (GUI) creator for producing a composition that modifies the software product by applying operational rules, said composition including an instruction set of commands therein; and
a memory for storing said commands in said instruction set as an adapted software product.

2. The processor according to claim 1, further comprising a validation filter for verifying application of said operational rules to said composition to produce an adapted software product.

3. The processor according to claim 2, further comprising an interpretive behavior interface module for executing said adapted software product.

4. The processor according to claim 1, wherein said composition is a well-formed flowchart (WFFC).

5. The processor according to claim 1, wherein said GUI creator provides a plurality of icons for constructing said composition.

6. A computer-implemented method for enabling an operator to reprogram a configurable software product, said processor comprising:
creating a composition using a graphical user interface (GUI) for modifying the software product,
applying operational rules to said composition for producing an instruction set of commands; and
sequencing said commands into an adapted software product.

7. The method according to claim 6, further storing said commands in said instruction set.

8. The method according to claim 6, further interpreting said adapted software product for operation.

9. The processor according to claim 8, further validating said adapted software product.

10. The processor according to claim 6, wherein said creating process provides a plurality of icons for constructing said composition.
